(19) United States
(12) Patent Application Publication
(10) Pub. No.: US 2026/0219296 A1
(43) Pub. Date: Jul. 30, 2026

(54) A PROBING DEVICE COMPRISING A HEAT TRANSFER ARRANGEMENT, A METHOD OF MANUFACTURING A PROBING DEVICE, AND A METHOD FOR PROBING A SAMPLE

(71) Applicant: TEKNOLOGIAN TUTKIMUSKESKUS VTT OY, Espoo (FI)

(72) Inventors: Janne LEHTINEN, Espoo (FI); Aapo VARPULA, Espoo (FI); Mika PRUNNILA, Espoo (FI)

(21) Appl. No.: 19/150,740

(22) PCT Filed: Feb. 5, 2024
(86) PCT No.: PCT/FI2024/050043

§ 371 Date: Jul. 24, 2025

(30) Foreign Application Priority Data
Feb. 8, 2023 (FI) 20235127

(51) Int. Cl. G01Q 70/14; G01Q 70/10; G01Q 70/16

(52) U.S. Cl. CPC G01Q 70/14; G01Q 70/10; G01Q 70/16

(57) ABSTRACT

A probing device comprising at least one tip portion configured to probe a sample, wherein the probing device is provided with a heat transfer arrangement, optionally provided in connection with the tip portion or as part of the tip portion, wherein said heat transfer arrangement is configured to cool or heat at least a portion of the probing device and comprises at least a first material portion and a second material portion, said material portions comprising at least one superconducting material portion and at least one other material portion comprising an insulating material portion, normal metal material or semiconductor material portion, wherein the material portions are arranged to form at least one tunnel junction comprising at least one superconductor-insulator-normal metal (SIN) junction, superconductor-insulator-semiconductor (SISm) junction, or superconductor-semiconductor junction (SSm). A method of manufacturing a probing device and a method for probing a sample.

### TECHNICAL FIELD OF THE INVENTION

The invention relates to probing devices in general. More specifically, the invention relates to a probing device comprising a tip portion, wherein the probing device comprises a heat transfer arrangement configured to heat or cool at least a portion of the probing device.

### BACKGROUND OF THE INVENTION

Many methods exist for probing of samples to determine properties of the sample, such as scanning thermal microscopy (SThM), scanning probing microscopy (SPM), and wafer probing techniques for measuring e.g. electric properties. Depending on the case, the probing environment may be at a certain temperature level, such as a cryogenic environment. It may be desirable to be able to operate the probing devices at the temperature of a certain probing environment or at a temperature of the sample that is probed. Currently, e.g. SThM is not readily available at cryogenic temperatures due to the lack of suitable thermometer materials and devices.

Regarding cryogenic applications, known solutions typically have probing devices that have minimum achievable temperatures of about 3-7 K. Even with the most powerful available devices utilizing 3He materials and being able to provide chuck temperatures below 1K, thermal coupling prevents low temperature probing below 1 K. Typically the probe head or tip temperature is also significantly higher (10-15 K) compared to the chuck temperature due to design constraints of the devices.

When the temperature of the probing device, specifically the probe head or tip portion of the device that is adapted to be in close contact with the sample, is at a temperature that is different from the sample temperature, the probe head may alter the sample temperature. For instance, in cryogenic environments the probe head may heat the sample, which is not desirable.

It would be advantageous to provide a probing device that may be better adapted for different temperature environments, such as a cryogenic environment. A probing device that may e.g. reach lower temperatures than the prior art probing devices would be desirable. Such devices could enable study of lower energy threshold quantum systems, as an example.

### SUMMARY OF THE INVENTION

An object of the invention is to alleviate at least some of the problems of the prior art. In accordance with one aspect of the present invention, a probing device is provided, the probing device comprising at least one tip portion configured to probe a sample, wherein the probing device is provided with a heat transfer arrangement, optionally provided in connection with the tip portion or as part of the tip portion, wherein said heat transfer arrangement is configured to cool or heat at least a portion of the probing device and comprises at least a first material portion and a second material portion, said material portions comprising at least one superconducting material portion and at least one other material portion comprising an insulating material portion, normal metal material or semiconductor material portion, wherein the material portions are arranged to form at least one tunnel junction comprising at least one superconductor-insulator-normal metal (SIN) junction, superconductor-insulator-semiconductor (SISm) junction, or superconductor-semiconductor junction (SSm).

A method of manufacturing a probing device may comprise providing a probing device with at least one tip portion, providing a heat transfer arrangement, optionally in connection to or as part of the tip portion, and configuring said heat transfer arrangement to cool or heat at least a portion of the probing device by providing the heat transfer arrangement through providing at least a first material portion and providing a second material portion, said material portions comprising at least one superconducting material portion and at least one other material portion comprising an insulating material portion, normal metal material or semiconductor material portion, and arranging the material portions to form at least one tunnel junction comprising at least one superconductor-insulator-normal metal (SIN) junction, superconductor-insulator-semiconductor (SISm) junction, or superconductor-semiconductor junction (SSm).

The heat transfer arrangement may be configured to thermally insulate at least a portion of the probing device.

The invention may provide a self-cooling or self-heating probing device, where temperature regulation of the probing device or at least a portion thereof, such as the tip/needle portion, may be provided by the heat transfer arrangement that is integrated with the probing device. The present invention may be adapted for use in cryogenic environments as a self-cooling probe. Yet, a self-heating probe may be suitable for use in higher temperature environments than current probe devices. The invention may provide a probing device that is capable of determining one or more characteristics of a sample, while at the same time altering (or maintaining) a temperature of at least a portion of the probing device itself to a suitable temperature.

Embodiments of the invention may provide probing devices that may operate at selected temperatures that are simpler than prior art probing devices as external cooling or heating may not be required. It may also be easier to attain a selected temperature of the probing device more accurately.

Especially in connection with cryogenic temperatures, the present invention may also enable provision of a tip portion of the probing device that has capability of reaching lower temperatures than prior art devices. A tip portion of the probing device may e.g. reach temperatures of under 8 K, under 4 K, under 1.2 K, or mK levels.

Yet even if the probing device itself is not cooled to a lower temperature than that of the prior art, with the present invention, a probing device may be provided with which a sample may be probed such that a temperature of the sample is essentially not increased as a result of the probing and/or is increased at least less than with prior art probing devices. This is due to a provided poor heat conductance, where the probe may not heat the sample even if there is a large temperature between the two.

The poor heat conductance (or high thermal isolation) between at least a portion of the probing device and a sample may allow the probing device to be used, instead of with the heating arrangement being actively used to heat or cool at the least a portion of the probing device, as a probing device performing a probing function, while the heating arrangement is configured to thermally insulate at least a portion of the probing device. Here, the heating arrangement may passively heat or cool at least a portion of the probing device.

With probing devices of the invention, however, the probing device and associated heat transfer arrangement may be used to cool or heat also the sample that is probed, if such functionality is desired. This may eliminate the need for separate cooling or heating devices or arrangements for temperature regulation of the sample.

Relating once more to cryogenic applications, instead of the probing device heating the sample, as occurs regularly in prior art devices, the probing device may be used to cool the sample.

The heat transfer arrangement may be executed in various ways. For instance, thermionic refrigeration or thermophotonic cooling may be employed. In other embodiments, the heat transfer arrangement may e.g. operate through thermoelectric cooling and comprise one or more Peltier elements.

In some embodiments, the at least one tunnel junction may be coupled to at least one adjacent material portion to form, at least considering at a cross-sectional axis of the device, at least one further junction comprising a superconductor-normal metal (SN) junction, a superconductor-semiconductor (SSm) junction, a superconductor-insulator-semiconductor (SISm) junction and/or an SIN junction.

The tip portion (which may also be referred to as a needle portion) of a probing device may be formed from at least one of the first, second, and optionally third material portions that participate in forming at least tunnel junction. Alternatively, the tip portion may be separate from the at least first and second material portions that participate in forming the at least one junction.

A probing device may be adapted to be used for at least one probing function selected from the group of: scanning probing microscopy (SPM), scanning tunneling microscopy (STM), scanning thermal microscopy (SThM), measurement of at least one electromagnetic property, measurement of at least one thermal property, measurement of at least one structural property, measurement of at least one surface property, and measurement of at least one optical property, optionally in a cryogenic environment.

With embodiments of the invention and heat transfer arrangements constructed through various material portions forming various junctions, a probing device may be configured to perform a probing function while simultaneously heating or cooling the probing device and optionally also the sample that is probed.

A probing device comprising one tunnel junction or Schottky junction may be used as a self-cooling probing device. Addition of further Schottky and/or tunnel junctions may enable additional cooling (further cooling with each added junction) and/or a further Schottky and/or tunnel junction may enable one or more probing functions.

In some embodiments, the probing device may be adapted to be used for at least two different probing functions, wherein one of said probing functions is measurement of at least one thermal property, such as thermometry. E.g. thermometry may then be provided as an integrated option in a probing device (or at least probe head or tip portion thereof). Separate devices and procedures for thermometry may then be eliminated.

A selected combination of material portions may provide a probing device with capability to perform e.g. thermometry as an inherent function. For instance, SIN and SSm junctions may be used as accurate thermometers.

In one embodiment, a sample may be heated or cooled and the amount of heating or cooling may be determined simultaneously. This may enable accurate determination of local temperature of the sample. Many different types of thermal properties of materials may be determined, A thermal conductance (or resistance) between the tip and sample (and/or between the sample and a sample holder), thermal conductivity, heat capacity, glass transition temperature, latent heat, and/or enthalpy of a sample may be determined, for instance, In one alternative embodiment, at least one electric property of a sample may be probed/determined and the temperature of the probing device may be simultaneously altered.

In some embodiments of the invention, the heat transfer arrangement may be arranged at the tip portion of the probing device, preferably as a layer structure wherein one of said material portions forms a core portion of the tip portion and said at least two other material portions are arranged as layer portions surrounding at least part of the core portion to form the at least one tunnel junction, such as SIN, SSm, or SISm junction and at least one further junction comprising an SN junction, an SSm junction, and/or a further SIN or SISm junction.

The tip portion of a probing device may additionally at least partially comprise a metal or superconducting coating as a further material portion. A selected coating for a tip portion may enable the use of the probing device for a selected function. For instance, a conductive material coating may enable the probing device to be adapted for performing at least a STM probing function.

Some embodiments of a probing device may additionally comprise at least a third or fourth material portion and optionally further material portions, comprising at least a superconducting material portion, insulating material portion, semiconductor material portion, or normal metal material portion, wherein the material portions are arranged to form at least three junctions in series, wherein each of said junctions is a Schottky junction or a tunnel junction. Any number of further material portions may be provided to provide further coupled junctions, such that each junction may act as a cooling junction or a junction used for a probing function.

A heat transfer arrangement comprising two or more cooling junctions may act as a multistage cooling arrangement, where each subsequent cooling junction may provide further cooling, enabling the e.g. tip portion of the probing device to be provided at a lower temperature than by utilizing fewer cooling junctions. In this case, the cooling junctions may comprise different superconducting materials comprising different superconducting energy gaps. For instance, a first superconducting material in a first cooling junction (such as SIN junction) may comprise e.g. vanadium, aluminum, tungsten, molybdenum, titanium nitride, niobium nitride, or niobium as a superconducting material, while a second, subsequent cooling junction (such as SIN junction) providing further cooling may comprise aluminum as a superconducting material.

The material portions of the heat transfer arrangement comprise at least one superconducting material portion, at least one insulating material portion, and at least normal metal material portion or semiconductor material portion, and the probing device may additionally comprise a cantilever portion, wherein the tip portion is coupled to the cantilever portion via one or more connecting portions such that the tip portion, cantilever portion, and/or connecting portion comprise a superconducting material portion, insulating material portion, and normal metal material portion. The probing device may comprise at least two connecting portions, each connecting portion comprising a superconductor portion coupled to an insulating portion, wherein the insulating portion is coupled to the tip portion. Here, the connecting portions may comprise flip-chip type bumps that couple a cantilever portion to the at least one tip portion (a plurality of tip portions may also be provided), with e.g. two to several thousands of bumps being provided per tip portion. Known methods may easily be used to manufacture such devices.

In yet one more embodiment of a probing device, the material portions of the heat transfer arrangement comprise at least one superconducting material portion, at least one insulating material portion, and at least normal metal material portion, and the tip portion may be arranged on a platform portion comprising a normal metal material portion, an insulating material portion being arranged to contact the platform portion at least at a first contact location on the platform portion, a superconducting material portion being arranged to contact said insulating material portion, wherein the probing device additionally comprises a plurality of further material portions comprising at least one subsequent insulator portion being arranged to contact the platform portion at least at a second contact location on the platform portion, at least one subsequent superconducting material portion being arranged to contact said subsequent insulating material portion, wherein said first and second contact locations are not overlapping and do not contact said tip portion.

A method of probing a sample is also provided according to independent claim 14.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 schematically illustrates exemplary probing devices according to embodiments of the invention.

FIG. 2 shows one example of a probing device according to an embodiment of the invention.

FIG. 3 exhibits a probing device according to an embodiment of the invention.

FIG. 4 shows embodiments of probing devices according to the invention.

FIG. 5 depicts embodiments of probing devices according to the invention.

FIG. 6 shows embodiments of probing devices according to the invention.

FIG. 7 shows embodiments of probing devices according to the invention.

FIG. 8 shows embodiments of probing devices with a cantilever.

FIG. 9 illustrates an exemplary probing device according to an embodiment of the invention.

FIG. 10 shows a probing platform that may be utilized with the invention.

FIG. 11 portrays alternative probing devices according to embodiments of the invention.

### DETAILED DESCRIPTION

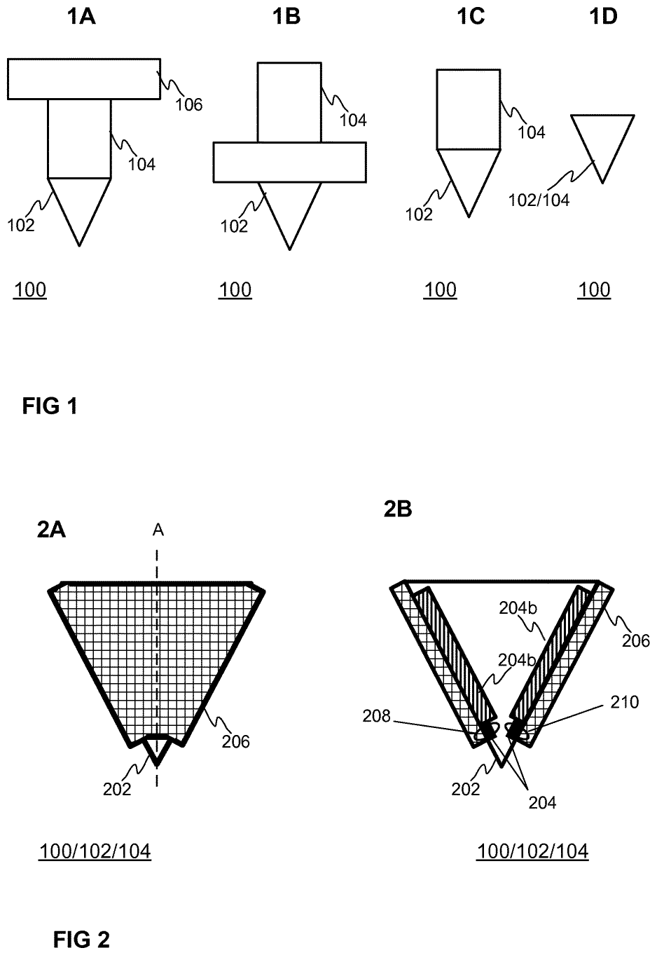

FIG. 1 shows at 1A, 1B, 1C, and 1D schematic illustrations of probing devices 100 according to embodiments of the invention. The probing device 100 comprises at least one tip portion 102 that is configured to probe a sample.

“Probing” may refer to functionality where the tip portion 102 is brought in vicinity of the sample with the intention of determining one or more characteristics of the sample. In some cases, “probing” may additionally or alternatively refer to functionality where the tip portion 102 is brought in vicinity of the sample with the intention of altering one or more characteristics of the sample.

Probing may comprise scanning probing microscopy (SPM), scanning tunneling microscopy (STM), scanning thermal microscopy (SThM), measurement of at least one electromagnetic property, measurement of at least one thermal property, or measurement of at least one optical property, for instance.

The probing device 100 is additionally provided with a heat transfer arrangement 104 that is configured to cool at least a portion of the probing device 100.

It should be noted that the figures presented herein are not drawn to scale. Some portions of the devices, such as material portions, may for demonstrative purposes be illustrated as being e.g. larger than in practical implementations when comparing to other portions of the device.

The heat transfer arrangement 104 may be configured to cool at least the tip portion 102 and may be provided in connection with the tip portion 102. The heat transfer arrangement 104 may be directly or indirectly coupled to the tip portion 102, as seen in FIGS. 1A and 1B, respectively. In the embodiments of FIGS. 1A and 1B, the probing device 100 additionally comprises a manipulation element 106. The manipulation element 106 may be adapted to enable or ease operation of the probing device or specifically the tip portion 102 thereof.

FIGS. 1C and 1D show probing devices 100 that do not comprise a manipulation element 106, which is not essential for the operation of a probing device 100. Yet also in these embodiments, a manipulation element may be provided, if the probing device 100 is provided as a portion of a larger probing entity. A larger probing entity may comprise any number of further elements, and may e.g. constitute a sensing device.

In the embodiment of FIG. 1D, the probing device 100 according to the invention may comprise only a probe head or the tip portion 102, wherein the heat transfer arrangement 104 is provided as part of the tip portion 102. In other words, the tip portion 102 may be configured to act as a heat transfer arrangement 104.

The heat transfer arrangement 104 may comprise at least a first material portion and a second material portion arranged to form at least one thermoelectric junction or at least one tunnel junction or Schottky junction. A third material portion may be provided, and the material portions may be arranged to form at least two thermoelectric junctions or at least two tunnel or Schottky junctions.

The heat transfer arrangement 104 preferably however comprises at least a first material portion and a second material portion, said material portions comprising at least one superconducting material portion and at least one other material portion comprising an insulating material portion, normal metal material or semiconductor material portion, wherein the material portions are arranged to form at least one tunnel junction comprising at least one superconductor-insulator-normal metal (SIN) junction, superconductor-insulator-semiconductor (SISm) junction, or superconductor-semiconductor junction (SSm).

A heat transfer arrangement comprising one of the aforementioned junctions may be used for one of a cooling or heating function at a given time instant. One tunnel junction may also be alternatingly used for a cooling/heating function and a probing function, such as thermometry function, with a selected bias. This may be enabled by a pulsed functioning, where the functioning between e.g. cooling and thermometry function is pulsed, such that a cooling pulse is long enough, a heating pulse is short enough, and a thermal time constant is large enough, that the sample is not heated during the thermometry functioning.

A relative change in temperature (or a less accurate temperature) may be measured simultaneously to a heating or cooling function by measuring a current that is flowing across the junction using a smaller AC current while the heating or cooling function is being carried out utilizing a larger DC current. This may be useful in a case where a temperature is to be adjusted while utilizing only one SIN junction.

A heat transfer arrangement comprising two of said junctions may be used for a cooling/heating function via one junction and a probing function via the at least one other junction simultaneously.

In the case of one first material portion, one second material portion, and one optional third material portion, each material portion may comprise a different material. The material portions may be selected according to the use case of the probing device 100 and/or according to the function of the heat transfer arrangement 104 (referring to e.g. operating temperature ranges of the probing device).

FIG. 2 shows at 2A a side view and at 2B a cross-sectional view (along a cross-sectional axis A of the device 100 or tip portion 102) of an embodiment of a probing device 100 where the heat transfer arrangement 104 is provided as part of the tip portion 102. In this embodiment, the heat transfer arrangement 104 and tip portion 102 are provided as a layered structure, the layer structure comprising at least three layers. The layers are not necessarily monolithic, but may be. The shape of layers may depend on used materials and deposition, lithography, and/or etching processes that may be employed to manufacture the probing device 100 or its different portions.

A first material portion 202 is provided as a core for the tip portion 102. It should be noted that the tip portion 102, or probing device 100 in general, may comprise further layers that are not part of the heat transfer arrangement 104. For example, the tip portion 102 may comprise a further outer coating layer comprising superconducting material.

A second material portion 204 is coupled to the first material portion 202. The second material portion 204 is an intermediate layer in the layer structure of the tip portion 102 of the embodiment of FIG. 2.

A third material portion 206 is provided coupled to at least the second material portion 204. In the embodiment of FIG. 2, the third material portion is provided as an outer layer or core portion of the tip portion 102.

In one embodiment, the material portions of FIG. 2 may be selected to provide thermoelectric junctions and the heat transfer arrangement 104 may be configured to operate as a Peltier device. In one alternative embodiment and referring to FIGS. 1A and 1B, the heat transfer arrangement 104 may be configured to operate as a Peltier device that is separate from the tip portion 102, yet coupled to the tip portion.

Returning to the embodiment of FIG. 2, the probing device 100 may be configured to be used in STM and the heat transfer arrangement 104 may be configured to cool the tip portion 102. Additionally, the probing device 100 may be used as a thermometer. In this case, the first material portion 202 may comprise normal metal (N), the second material portion 204 may comprise insulating material (I), and the third material portion 206 may comprise superconducting material(S).

The material portions may be arranged in the heat transfer arrangement such that at least a first superconductor-insulator-normal metal (SIN) junction 208 (indicated in the figure for illustrative purposes) is provided. In the embodiment of FIG. 2, the first SIN junction 208 surrounds the tip portion 102 and forms an annular structure. It could also be considered that at least along one cross-sectional axis of the device 100 or at least a tip portion of the device, the first SIN junction 208 may be considered to be coupled with at least the second material portion 204 and third material portion 206 to form a second SIN junction 210. The junctions referred to herein may therefore also effectively be formed, in the simplest case, from a structure with two material layers.

It could also be considered that the first SIN junction is coupled with itself to form the second SIN junction 210. Considering at least a cross-sectional area of the probing device, the heat transfer arrangement 104 may comprise material portions arranged to form at least two tunnel junctions that are coupled in series.

The second material portion 204 may be a (tunnel) junction insulator portion and may be provided separately, or it may be provided in connection with a further insulating material portion 204b, with the junction insulator portion 204 and further insulating material portion 204b constituting an intermediate layer portion of the tip 102. The further insulating material portion 204b may comprise a thickness that is larger than that of the junction insulator material portion 204. It should be noted that material portions of the figures are not drawn to scale and especially the thicknesses of junction insulator portions are exaggerated. In cases where an insulating material portion participates in forming of an SIN (or SISm) junction, the insulating material portion always comprises at least a junction insulator portion.

Regarding thicknesses of the material portions and excluding thickness of the junction insulator portion(s), the thicknesses may vary on a large scale and may not be as relevant for the functioning of the device as the thickness of the junction insulator portion in the case of tunnel junctions. The material portions (except for tunnel junction insulator portions) may e.g. comprise thicknesses ranging from some nanometers to a few micrometers, such as between 10 nm and 5 μm.

A thickness of the second material portion 204 or generally of a tunnel junction insulator portion may be under about 2 nm. A tunneling current through the tunnel junction will exponentially depend on the thickness of the junction insulator portion 204. A further insulating material portion 204b may comprise a thickness of e.g. over 4 nm, or for instance 20-200 nm. An insulating material portion as a second material portion and participating in the formation of at least one junction may generally be considered as comprising at least a junction insulator portion 204. In this text and in connection with some embodiments, any insulting material portion may be considered to additionally comprise a further insulating material portion 204b.

A superconducting material may comprise for instance vanadium (V), indium (In), and/or niobium (Nb) (e.g. in layers), an insulating material may comprise silicon dioxide (SiO₂) or aluminum oxide (AlOx), and a normal metal material may comprise any metal, to give a few examples of materials that may be used.

It should be noted that what is referred to herein as a “normal metal material” or N may refer to a non-superconducting metal material, and also in some embodiments may refer to a lightly doped semiconductor material, which may also be referred to as Sm. Any SIN junction may thus also be realized as an SISm junction even if not explicitly given as an alternative.

The heating or cooling functionality of a heat transfer arrangement may be carried out by providing a selected voltage across the at least one junction of the heat transfer arrangement. For instance, to enable to tunneling of charged particles from a normal metal material or semiconducting material to a superconducting material via a provided Schottky or tunnel junction, the charged particles shall comprise an energy that is slightly less than the superconducting energy gap of the superconducting material due to thermal broadening. When the selected voltage is applied, charged particles with highest energy may tunnel from the normal metal material or semiconducting material to the superconducting material, thereby cooling the normal metal material or semiconducting material.

A superconducting material of a heat transfer arrangement may be selected based on an operating temperature of the probing device and/or a temperature at which said heating or cooling should occur. The superconducting material may be selected to provide a selected superconducting energy gap. A superconducting material comprising a lower superconducting energy gap may be utilized in connection with lower temperatures and a superconducting material comprising a higher superconducting energy gap may be utilized in connection with higher temperatures. A probing device may thus be tailored, via material and/or voltage selections, to operate in connection with a selected temperature or temperature range.

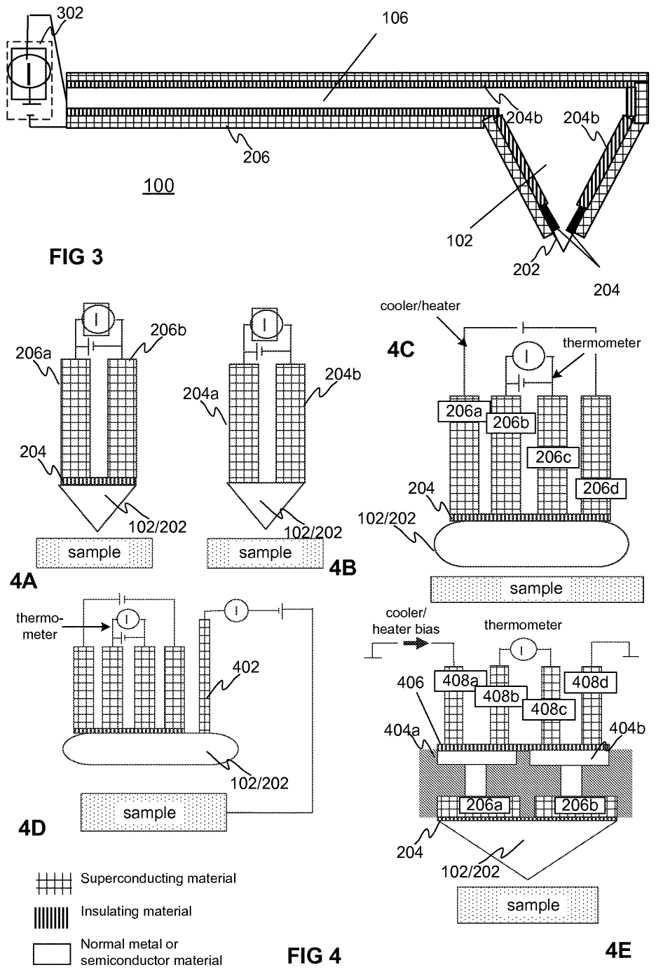

FIG. 3 shows a probing device corresponding to the probing device of FIG. 2 but comprising a manipulation element or cantilever portion 106. Here, the heat transfer arrangement is formed as part of the tip portion 102 and the cantilever portion 106. The probing device 100 may be constructed from a first material portion 202, which may comprise a normal metal material, second material portion 204, which may comprise an insulating material, and a third material portion 206, which may comprise a superconducting material.

The second material portion 204 may comprise a junction insulator portion and a further insulating material portion 204b, with thicknesses as specified in connection with FIG. 2.

In general, depending on the number of isolated junctions in the probing device, the probing device may be used as a thermometer, cooler, and/or tunnel probe. With one tunnel junction or Schottky junction, the probing device may either be used for a probing function or may act as a probing device with a (self-) cooling arrangement.

The probing device 100 may be coupled to one or more voltage sources 302. With the voltage source(s) 302, the junctions of the probing device 100 may be biased. Depending on the bias, heating or (multistage) cooling, thermal isolation, or determination of a tunnel current may be carried out.

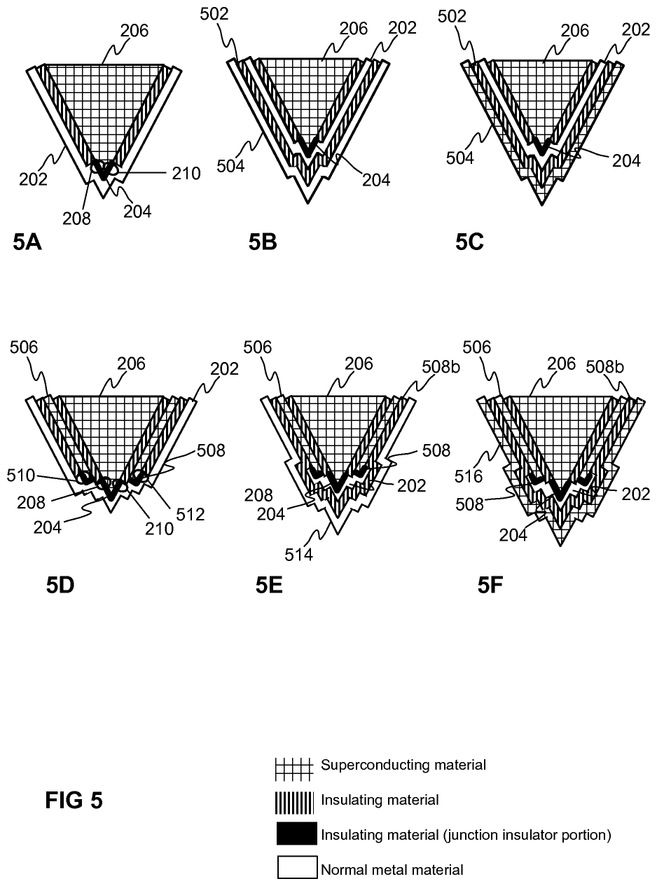

FIG. 4 shows schematic examples of probing devices 100 that may be utilized in e.g. SPM probing. In these examples, a plurality of separate isolated Schottky or SIN tunnel junctions are provided in the same probing device 100.

It may be noted that either an insulating or conductive outer layer may be provided for a tip portion, depending on the SPM or other probing type of function that the device is intended to be used for. A conductive outer layer for a tip portion may be utilized in e.g. STM or electrical function probing. An insulating outer layer for a tip portion may be used to protect one or more junctions of the probing device and/or to avoid short circuiting in the case of e.g. a conductive sample that may contact the tip.

FIG. 4A shows a probing device 100 with a tip portion 102 comprising a first material portion 202, comprising a normal metal material, a second material portion 204 comprises an insulating material, while a third material portion 206 is provided as two separate elements 206a, 206b and comprises superconducting material.

FIG. 4B shows a probing device 100 with a tip portion 102 comprising a first material portion 202, comprising a normal metal material or advantageously a semiconducting material, and a second material portion 204 is provided as two separate elements 204a, 204b and comprises insulating material.

FIG. 4C illustrates a probing device 100 with a tip portion 102 comprising a first material portion 202, which comprises a normal metal material, a second material portion 204 comprises an insulating material, while a third material portion 206 is provided as four separate elements 206a, 206b, 206c, 206d and comprises superconducting material. The example of FIG. 4C may be utilized for thermometry with heating and cooling ability. Depending on the bias current, heating or cooling may be provided.

FIG. 4D is otherwise similar to the embodiment of FIG. 4C, but comprises an additional material portion 402 comprising superconducting material that is in direct contact with the tip portion 102. An electric contact provided between the sample and additional superconducting material portion 402 may enable measuring current between the sample and the tip. The additional material portion 402 may also comprise a normal metal material.

FIG. 4E shows a probing device 100 with a tip portion 102 comprising a first material portion 202 comprising a normal metal material (first normal metal material portion). A second material portion 204 comprises insulating material (first insulating material portion), and third material portion 206a, 206b comprises superconducting material (first insulating material portion). Further material portions may comprise second normal metal material portion 404a, 404b, second insulating material portion 406, and second superconducting material portion 408a, 408b, 408,c, 408d. The example of FIG. 4E illustrates a possible probing device 100 that may provide a cascaded cooling (or heating) effect through multiple stages of cooling (or heating). Better thermal isolation for the tip portion is also provided.

FIG. 5 illustrates further schematic examples of probing devices 100 or portions thereof that may be used e.g. for probing of electric properties of a sample, probing of thermal properties of a sample, and/or STM. The examples of FIGS. 5-7 are schematic illustrations depicting cross-sectional views of at least tip portions 102 of probing devices. In the examples of FIG. 5, the heat transfer arrangement 104 is provided as part of the tip portion 102, where a superconducting material portion 206 forms a core of the tip portion 102.

FIG. 5A shows an example where the superconducting material portion 206 is surrounded by an insulating material portion 204 forming a second layer of the tip portion 102. The insulating material portion 204 comprises a junction insulator portion and a further (thicker) insulating material portion (corresponding to 204b of FIG. 2). Yet, it may be noted that a layer may surround only a portion of a core portion of the device.

In FIG. 5A, a normal metal material portion 202 is provided adjacent to the insulating material portion 204 as a third and outer layer of the tip portion. The material portions are arranged to form a first SIN junction 208 that forms an annular structure around the tip portion of the device or, in other words, a first SIN junction 208 is coupled to an adjacent material portion to form a second SIN junction 210.

In FIG. 5B, a (first) normal metal material portion 202, (first) insulating material portion 204, and (first) superconducting material portion 206 correspond to that of FIG. 5A, while a fourth material portion 502 comprising isolating insulating material is provided adjacent to the normal metal material portion 202 as a fourth layer portion and a fifth material portion 504 comprising isolated normal metal material is provided as a fifth layer portion as an outer layer of the tip portion 102 of the device.

The (first) normal metal material portion 202, (first) insulating material portion 204, and (first) superconducting material portion 206 can be considered as the first, second, and third material portions that are arranged to form the first SIN junction (and second SIN junction), which are not explicitly pointed out in the figures, but essentially correspond to the first and second SIN junctions 208 and 210 in previous figures.

The embodiment of FIG. 5C corresponds to that of FIG. 5B, but the fifth material portion 214 comprises superconducting material. In FIGS. 5B and 5C, the fourth material portion 502 insulates the fifth material portion 504, which is adapted to provide an isolated conducting outer layer for the tip portion to be used in a probing function.

In the embodiment of FIG. 5D, a first superconducting material portion 206 is surrounded by a first insulating material portion 204. A first normal metal material portion 202 is provided as an outer layer for the tip portion of the device. The first superconducting material portion 206, first insulating material portion 204, and first normal metal material portion 202 may be considered as the first, second, and third material portions that make up the first and second SIN junctions 108 and 110.

The embodiment of 5D further comprises a fourth material portion 506 that is a second superconducting material portion 506, adjacent to the first insulating material portion 204. A fifth material portion 508 is also provided as a second insulating material portion 508 that is layer portion between the second superconducting material portion 506 and the first normal metal material portion 202. The second insulating material portion 508 (as does the first insulating material portion 204) comprises a junction insulator portion and a further insulating material portion. The material portions, here the first normal metal material portion 202, the second insulating material portion 508, and the second superconducting material portion 506 are arranged to form at least one further SIN junction 510 as an annular structure, which may also be considered as forming a third SIN junction 510 and fourth SIN junction 512 when considering a cross-sectional view of the device or tip portion 102.

Any number of further material portions or layers could be added to an embodiment corresponding to that of FIG. 5D to form even further SIN junctions. Such material portions may comprise at least further insulating material portions comprising junction insulator portions, so that any adjacent normal metal material portion and superconducting material portion that are separated by a junction insulator portion constitute an SIN junction.

In the embodiment of FIG. 5E, the first superconducting material portion 206 forming the core of the tip is surrounded by a first insulating material portion 204 as a layer, while a first normal metal material portion 202 is provided as a partial layer portion. The aforementioned material portions may be considered as the first, second, and third material portions that make up the first and second SIN junctions 108 and 110.

A fourth material portion may be provided as a second superconducting material portion 506 that is adjacent to at least a part of the first insulating material portion 204 and forms a partial layer of the tip. A fifth material portion may be provided as a second insulating material portion 508 that is provided at an interface between the first normal metal material portion 202 and the second superconducting material portion 506. The second insulating material portion 508 may comprise at least a junction insulator portion, and may also be considered to comprise a thicker, second further insulating material portion 508b that may be provided as a full layer portion for the tip, functioning as an insulator for a second normal metal material portion 514 that may then be isolated and provide a probing function for the device as an outer layer.

The second superconducting material portion 506, second insulating material portion 508, and first normal metal material portion 202 may form third and fourth SIN junctions 510, 512. Junctions are not marked in FIG. 5E, but the skilled person may comprehend that such tunnel junctions may be formed at the interfaces comprising the junction insulator portions.

The embodiment of FIG. 5F essentially corresponds to that of FIG. 5E, but the outer layer of the tip is provided as a third superconducting material portion 516.

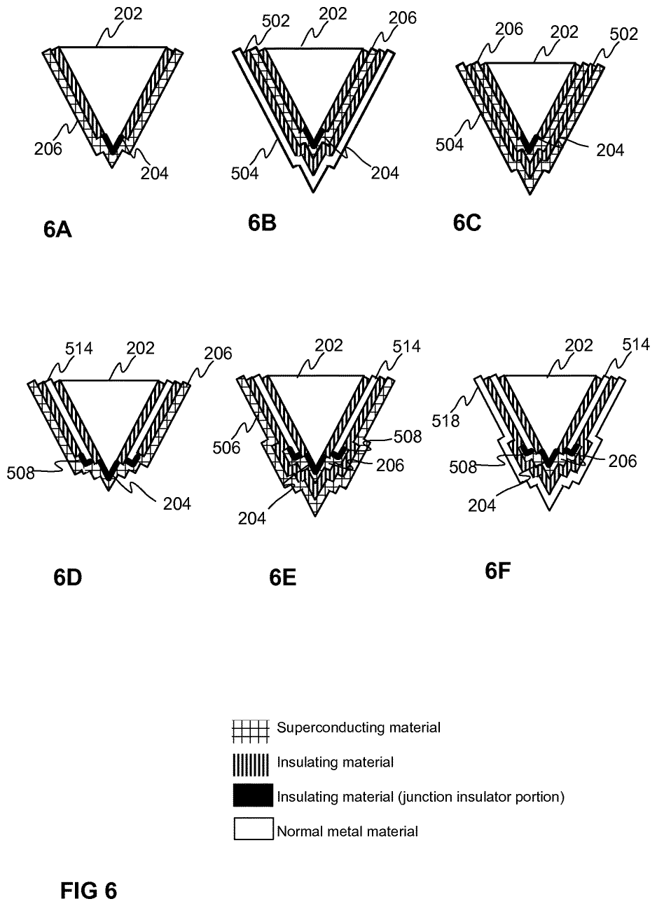

FIG. 6 illustrates further schematic examples of probing devices 100 or portions thereof that may be used e.g. for probing of electric properties of a sample, probing of thermal properties of a sample, and/or STM. In the examples of FIG. 5, the heat transfer arrangement 104 is provided as part of the tip portion 102, where a normal metal material portion 202 forms a core of the tip portion 102.

FIGS. 6A-6F show different examples of how material portions may be arranged to provide at least one SIN junction in the probing device in the case where a core portion of a tip is formed from normal metal material. The considerations explained in connection with FIG. 5 apply also in the case of FIG. 6, but with the ordering of material portions being different as shown by the figure legend.

Depicted are a first normal metal material portion 202, first insulating material portion 204, and first superconducting material portion 206 that form at least a first SIN junction.

Embodiments of FIGS. 6B and 6C may comprise a fourth material portion 502 (isolating insulating material portion) and fifth material portion 504 (isolated conducting normal metal or superconducting material portion) to provide an isolated conducting probing tip portion.

Further embodiments may comprise further material portions (such as a second normal metal material portion 514, second superconducting material portion 506, and third normal metal material portion 518) arranged to provide further SIN junctions and/or isolated tip layer portions as may be comprehended by the skilled person.

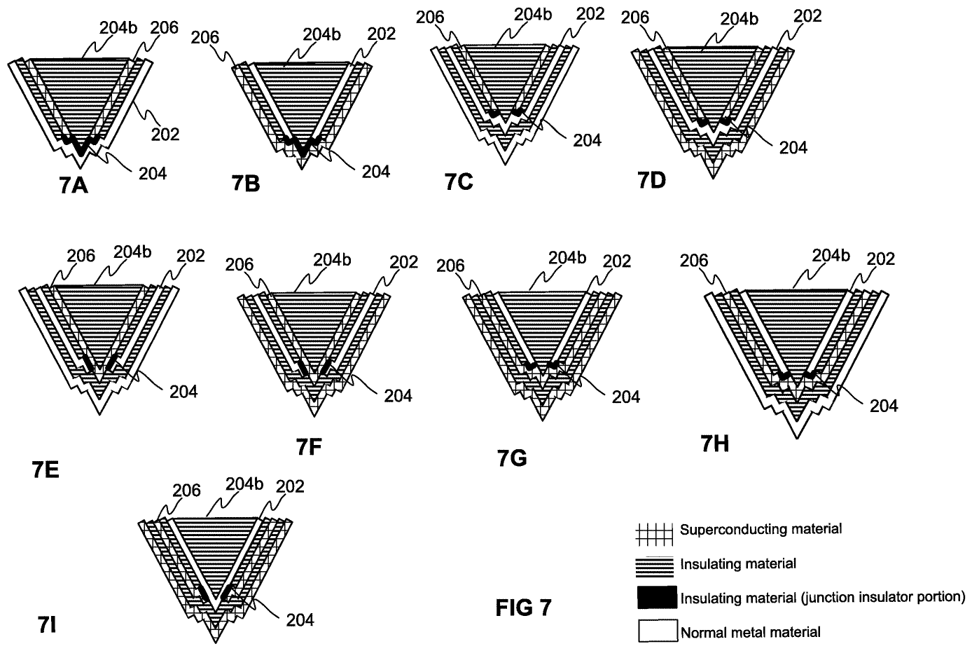

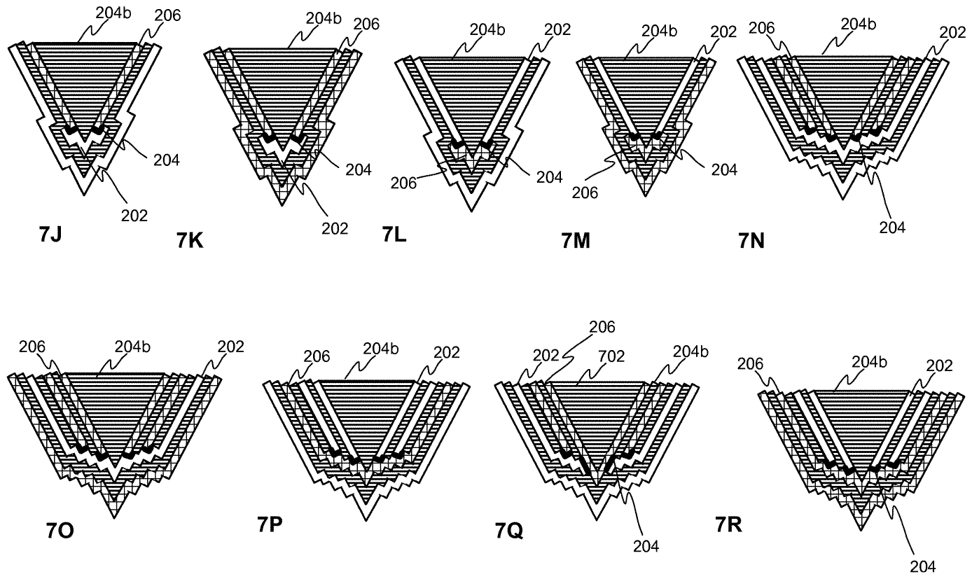

FIG. 7 illustrates further schematic examples of probing devices 100 or portions thereof that may be used e.g. for probing of electric properties of a sample, probing of thermal properties of a sample, and/or STM. In the examples of FIG. 5, the heat transfer arrangement 104 is provided as part of the tip portion 102, where an insulating material portion forms a core of the tip portion 102.

In embodiments of FIGS. 7A-7P and 7R, the first insulating material portion 204 is considered as comprising the thicker core material portion labelled as 204b and the junction insulator portion coupled thereto. In the embodiment of FIG. 7Q, the core may be a subsequent insulating material portion labelled as 702, which is not the first insulating material portion 204 that is participating in the forming of the first SIN junction, as may be easily understood from the figures.

FIGS. 7A-7R show exemplary devices with differing numbers of material portions and SIN junctions, the figures depicting labeling for the first normal metal material portions 202, the first insulating material portions 204, and first superconducting material portions 206.

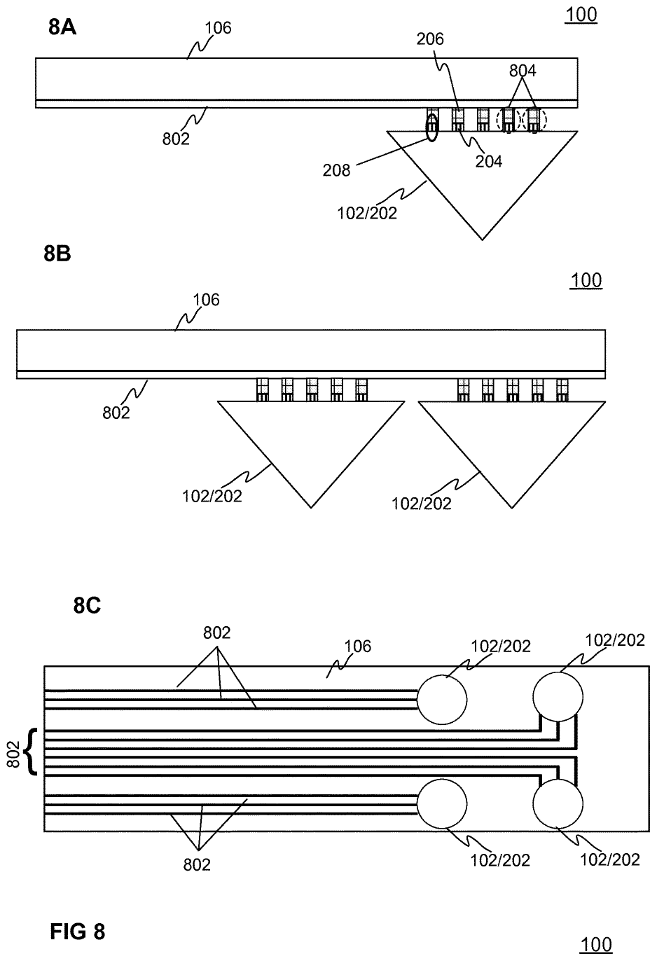

FIG. 8 depicts embodiments of probing devices 100 comprising a cantilever 106, where the heat transfer arrangement is provided between the tip portion 102 and the cantilever 106. FIGS. 8A and 8B show side views of the devices, while FIG. 8C depicts the device as viewed from below or from a viewing angle where a probed sample may reside.

The cantilever 106 may comprise a normal metal material, semiconductor material, or insulating material. The cantilever 106 also comprises or is coupled to trace elements 802. The trace elements 802 are coupled to at least one tip portion 102. Trace elements 802 may comprise normal metal or degenerate semiconductor material for signal routing. The trace elements 802 may be insulated from the cantilever 106.

The cantilever 106 and/or trace elements 802 are coupled to the at least one tip portion 102 via connecting portions 804. The material portions of the probing device may be arranged so that the tip portion and each connecting portion forms at least one SIN junction 208. In FIG. 8, the connecting portions 804 each comprise an insulating material portion 204 and a superconducting material portion 206. The connecting portions may be formed using flip chip bumps, for instance, and it should be noted that the thickness of the insulating material portion 204 is e.g. 1-2 nm and is usually considerably smaller than the thickness of the superconducting material portion 206 (which may be e.g. at least 100 nm), which is not reflected by the figures.

The material portions of probing devices 100 comprising connecting portions 802 may be arranged also differently, such that tunnel junctions are formed at differing interfaces. For instance, the tunnel junction(s), e.g. SIN junction 208 may be formed between the cantilever portion and a connecting portion, between a tip portion and a connecting portion, and/or between the tip portion and cantilever portion, as a part of the connecting portion(s) 804.

An embodiment of a probing device and heat transfer arrangement such as seen in e.g. FIG. 8A may be configured to passively for instance cool a portion of the probing device, such that the cooling is not actuated through directing a current through the at least one junction.

FIGS. 8B and 8C show embodiments of probing devices 100 comprising a plurality of tip portions 102.

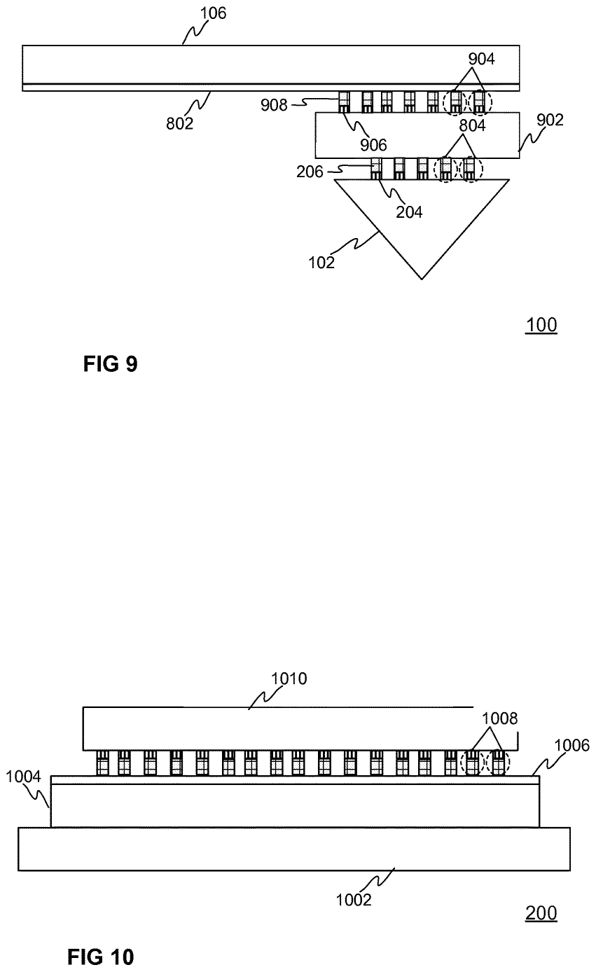

FIG. 9 shows a probing device 100 where a cantilever 106 comprising one or more trace elements 802 is coupled to a tip portion 102, where the tip portion comprises a normal metal material portion 202 that is coupled to a plurality of connecting portions 804 (each with an insulating material portion 204 and a superconducting material portion 206).

The coupling between the cantilever 106 and the tip portion is further realized by the connecting portions 804 being coupled to an intermediate element 902, which comprises or is further coupled to further connecting portions 904, each comprising an insulating material portion 906 and a superconducting material portion 908. The further connecting portions 904 are coupled to the trace elements 802.

The heat transfer arrangement comprising the intermediate element 902 and further connecting portions 904 may be used to cool the tip portion 102 to a temperature that is lower than that of e.g. the embodiment of FIG. 8.

In other embodiments, even more stages of further intermediate elements 902 and further connecting portions 904 may be provided to provide more cooling stages for the tip portion 102. A cascade cooling system may be provided, with each stage providing a lower temperature to attain even lower temperatures for the tip portion 102.

FIG. 10 depicts a probing platform 200 onto which a sample to be probed may be placed. The cooling platform may be used with any of the probing devices 100 disclosed herein to provide a probing system.

The probing platform may comprise a chuck 1002 and a heat transfer arrangement for heating or cooling a sample. The heat transfer arrangement may comprise a first material portion 1004 comprising semiconducting material. A second material portion 1006 may comprise superconducting material. A plurality of connecting portions 1008 may connect the second material portion 1006 to a third material portion 1010 comprising semiconducting material. The connecting portions 1008 of a probing platform may be similar to those utilized in a probing devices as disclosed above.

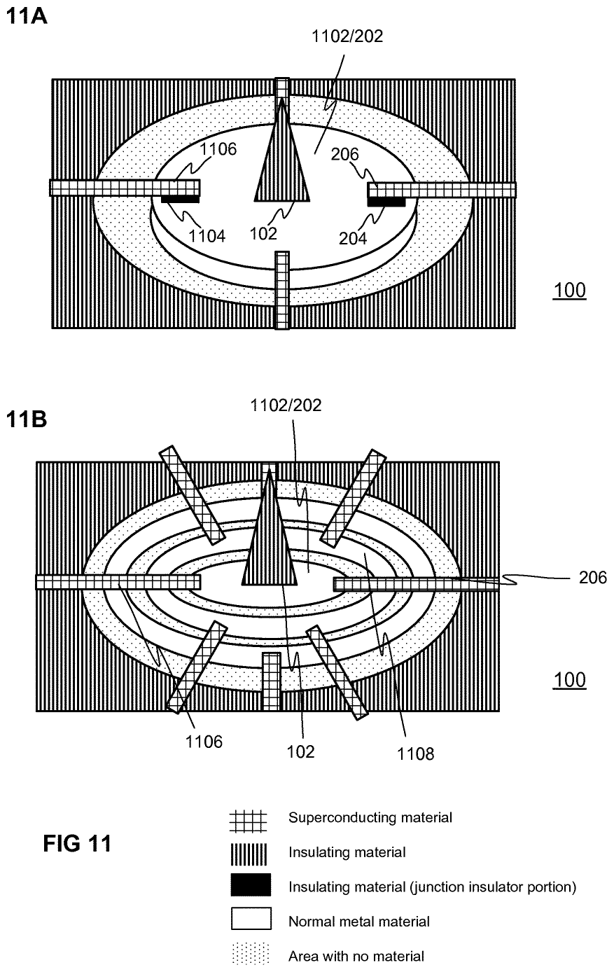

FIG. 11 shows further embodiments of probing devices 100. Here, a tip portion 102 is arranged on a platform portion 1102. The tip portion 102 may comprise insulating material. The platform portion may comprise or be formed from at least a first normal metal material portion 202. At least one first insulating material portion 204 (junction insulator portion with thicknesses as specified earlier) may be arranged to contact the platform portion 1102 at least at a first contact location on the platform portion. The first insulating material portion 204 may be arranged to contact a first superconducting material portion 206, that extends from the first location on the platform portion to outside the platform portion 1102. The first normal metal material portion 202, first insulating material portion 204, and first superconducting material portion 206 may be configured to form a first SIN junction.

The probing device may additionally comprise a plurality of further material portions comprising at least one subsequent insulator portion 1104 being arranged to contact the platform portion 1102 at least at a second contact location on the platform portion and at least one subsequent superconducting material portion 1106 being arranged to contact the subsequent insulating material portion 1104, wherein the first and second contact locations are not overlapping and do not contact the tip portion 102. Each subsequent insulator portion 1104 and subsequent superconducting material portion 1106 may form a further SIN junction with the platform portion 1102. The subsequent superconducting material portions 1106 all preferably are in contact with a subsequent insulator portion 1104, which is however not visible in the all of the associated figures as it is located between the subsequent superconducting material portion and the platform portion.

FIG. 11B shows an alternative probing device 100, where the platform portion comprises a plurality of isolated portions, with a first platform portion 1102 and further platform portions 1108, which each comprise normal metal material portions. The superconducting material portions 206, 1106, each extend from the contact location on the first platform portion 1102 to outside of all the further platform portions, preferably so that the superconducting material portions 20, 1106 are arranged to also be coupled to each further platform portion 1108 via an insulating material portion (junction insulator), which is not depicted in the figure.

The embodiments of FIG. 11 depict a probing device 100 where the tip portion 102 may be horizontally isolated from the environment. In FIG. 11B, the probing device may provide multistage cooling for the tip portion 102, as each further platform portion or ring structure may be configured to be cooled to a lower temperature than a previous platform portion, starting from the outermost platform portion.

Embodiments such as those of FIGS. 11A and 11B may also have different arrangements of materials in the different material portions so at to provide the at least one tunnel junction or Schottky junction.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. A probing device comprising at least one tip portion configured to probe a sample, wherein the probing device is provided with a heat transfer arrangement, optionally provided in connection with the tip portion or as part of the tip portion, wherein said heat transfer arrangement is configured to cool or heat at least a portion of the probing device and comprises at least a first material portion and a second material portion, said material portions comprising at least one superconducting material portion and at least one other material portion comprising an insulating material portion, normal metal material or semiconductor material portion, wherein the material portions are arranged to form at least one tunnel junction comprising at least one superconductor-insulator-normal metal (SIN) junction, superconductor-insulator-semiconductor (SISm) junction, or superconductor-semiconductor junction (SSm).

2. The probing device of claim 1, wherein said at least one tunnel junction is coupled to at least one adjacent material portion to form, at least at a cross-sectional axis of at least a portion of the device, at least one further junction comprising a superconductor-normal metal (SN) junction, a superconductor-semiconductor (SSm) junction, a superconductor-insulator-semiconductor (SISm) junction, and/or a superconductor-insulator-normal metal (SIN) junction.

3. The probing device of claim 1, wherein the probing device is adapted to be used for at least one probing function selected from the group of: scanning probing microscopy (SPM), scanning tunneling microscopy (STM), scanning thermal microscopy (SThM), measurement of at least one electromagnetic property, measurement of at least one thermal property, measurement of at least one structural property, measurement of at least one surface property, and measurement of at least one optical property, preferably in a cryogenic environment.

4. The probing device of claim 1, wherein the probing device is adapted to be used for at least two different probing functions, wherein one of said probing functions is thermometry.

5. The probing device of claim 1, wherein the heat transfer arrangement is arranged at the tip portion of the probing device, preferably as a layer structure wherein one of said material portions forms a core portion of the tip portion and said at least one or two other material portions are arranged as layer portions surrounding at least part of the core portion to form the at least one tunnel junction and optionally at least one further junction comprising an SN junction, an SSm junction, and/or a further SIN or SISm junction.

6. The probing device of claim 1, wherein the tip portion additionally at least partially comprises a metal or superconducting coating.

7. The probing device of claim 1, wherein the device additionally comprises at least one further material portion comprising a superconducting material portion, insulating material portion, or normal metal material portion, wherein the material portions are arranged to form at least three junctions in series, wherein each of said junctions is a Schottky junction or a tunnel junction.

8. The probing device of claim 1, wherein the material portions of the heat transfer arrangement comprise at least one superconducting material portion, at least one insulating material portion, and at least normal metal material portion or semiconductor material portion, and wherein the probing device additionally comprises a cantilever portion, wherein the tip portion is coupled to the cantilever portion via one or more connecting portions such that the tip portion, cantilever portion, and/or connecting portion comprise the superconducting material portion, insulating material portion, and semiconductor or normal metal material portion, preferably wherein the probing device comprises at least two connecting portions, each connecting portion optionally comprising a first material portion coupled to a second material portion, wherein the insulating portion is coupled to the tip portion.

9. The probing device of claim 8, wherein the probing device comprises a plurality of tip portions.

10. The probing device of claim 1, wherein the material portions of the heat transfer arrangement comprise at least one superconducting material portion, at least one insulating material portion, and at least normal metal material portion, and the tip portion is arranged on a platform portion comprising the normal metal material portion, the insulating material portion being arranged to contact the platform portion at least at a first contact location on the platform portion, the superconducting material portion being arranged to contact said insulating material portion, wherein the probing device additionally comprises a plurality of further material portions comprising at least one subsequent insulator portion being arranged to contact the platform portion at least at a second contact location on the platform portion, at least one subsequent superconducting material portion being arranged to contact said subsequent insulating material portion, wherein said first and second contact locations are not overlapping and do not contact said tip portion.

11. A method of manufacturing a probing device, the method comprising providing a probing device with at least one tip portion, providing a heat transfer arrangement, optionally in connection to or as part of the tip portion, and configuring said heat transfer arrangement to cool or heat at least a portion of the probing device by providing the heat transfer arrangement through providing at least a first material portion and providing a second material portion, said material portions comprising at least one superconducting material portion and at least one other material portion comprising an insulating material portion, normal metal material or semiconductor material portion, and arranging the material portions to form at least one tunnel junction comprising at least one superconductor-insulator-normal metal (SIN) junction, superconductor-insulator-semiconductor (SISm) junction, or superconductor-semiconductor junction (SSm).

12. The method of claim 11, wherein the providing of the heat transfer arrangement comprises providing
at least two junctions comprising the at least one tunnel junction and at least one further junction comprising a further tunnel junction or a Schottky junction.

13. The method of claim 11, comprising at least
coupling said at least one SIN, SSm, or SISm junction to at least one further provided adjacent material portion to form at least one further junction comprising a superconductor-normal metal (SN) junction, a superconductor-semiconductor (SSm) junction, and/or a SIN junction,
the method further comprising providing a tip portion, wherein said tip portion is formed to comprise at least one of said material layers.

14. A method for probing a sample, the method comprising
providing a probing device according to claim 1,
providing a sample to be probed,
allowing the tip portion of the probing device to physically, chemically, and/or electromagnetically interact with the sample.
